(19) United States
(12) Patent Application Publication
(10) Pub. No.: US 2008/0294767 A1
(43) Pub. Date: Nov. 27, 2008

(54) Ubiquitous Wireless Network System, Node Module, and Operation Method of the Node Module

(76) Inventor: Sung-Il Hwang, Seoul (KR)

Correspondence Address: Jefferson IP Law, LLP, 1730 M Street, NW, Suite 807, Washington, DC, 20036, US

(21) Appl. No.: 11/751,961

(22) Filed: May 22, 2007

(51) Int. Cl. G06F 15/173

(52) U.S. Cl. 709/224

(57) ABSTRACT

A ubiquitous wireless network system, node module, and operation method of the node module are disclosed. The present invention allows a display unit to display detected information or received information when the information corresponds to its own node module as an arrival destination. Therefore, the present invention enables users to ascertain the surrounding physical context around the corresponding node module or the information inputted by the administrator.

### BACKGROUND OF THE INVENTION

1. Field of the Invention

The present invention relates to a ubiquitous network. More particularly, the present invention relates to node modules included in the ubiquitous network.

2. Description of the Related Art

Recently, brilliant developments in science and engineering, particularly computer and communication technology, have been applied more and more to users' devices to make users' lives more convenient. With computer and communication technology, ubiquitous technologies have been gradually developed to provide various conveniences to users gathering information from their surrounding context.

Of the ubiquitous technologies, there is technology related to a network system that includes a plurality of node modules and a base module, which can perform mutual wireless communication with each other and an administration server. The following is a brief description of this network system.

The plurality of node modules is operated in such a way that a node module detects the surrounding physical context (temperature, humidity, etc.) and then transmits this information to its adjacent node module. The adjacent node module transmits the information to another adjacent node module, and such an information transmitting procedure continues until the information is received by the base module as the last stage. The based module transmits the information to the administration server, such that the administration server can monitor the surrounding physical context of the node module based on this information. As such, the administrator can monitor the surrounding physical context around the plurality of node modules, based on the received information. Accordingly, an administrator can read the surrounding physical context of the plurality of node modules through the information that is transmitted to the administration server from the respective node modules via the base module, and then manually or automatically control that context.

Such a ubiquitous wireless network system was filed in the Korean Intellectual Patent Office by the present applicant, and assigned to Korean Patent Application serial No. 10-2005-0017720, entitled “SENSOR NETWORK MODULE WITH USB PORT” which is incorporated herein by reference. In that application, the ubiquitous technology was proposed as more advance than its earlier technology known before the application was filed.

The ubiquitous wireless network system has advantages from the viewpoint of installation and use convenience, since the plurality of node modules and the base nodule can perform mutual wireless communication. Therefore, researchers attest that such a ubiquitous wireless network system is the most practical technology in the ubiquitous field.

However, the conventional ubiquitous wireless network system has the following problems.

Firstly, although the respective node modules detect the surrounding physical context around them and then transmit the information of the detected surrounding physical context to the administration server such that the administration server can read and control the surrounding physical context of the respective node modules, users around the respective node modules will be unaware of any changes to the surrounding physical context. This problem may make result in an administrator conducting a one-sided control of the context without considering an individual physical context that preferably should be processed for each user.

Secondarily, since the respective node modules and the base module serve to only transmit the information of the detected context to the administration server, the conventional ubiquitous wireless network system is merely operated such that it can only collect the information from the surrounding physical context.

### SUMMARY OF THE INVENTION

Accordingly, the present invention has been made to address the above-mentioned problems and/or disadvantages, an object of the present invention is to provide a technique enabling users around respective node modules to read the information of a surrounding physical context through the node modules.

It is another object of the present invention to provide a technique enabling users around respective node modules to read the information that is transmitted from an administration server to the node modules.

In accordance with an aspect of the present invention, a ubiquitous wireless network node module is provided. The module comprises a wireless communication unit for transmitting/receiving information between adjacent node modules, a destination determining unit for determining arrival destination of the information received through the wireless communication unit, a display unit for displaying the information when the arrival destination is its own node module, and a controller for performing control in such a way that the information is displayed through the display unit when the arrival destination of the information is its own node module and is transmitted to adjacent node modules through the wireless communication unit when the arrival destination of the information is not its own node module.

In accordance with another aspect of the present invention, another ubiquitous wireless network node module is provided. The module comprises a wireless communication unit for transmitting/receiving information between adjacent node modules, a detector for detecting a surrounding physical context, a display unit for displaying information of the detected surrounding physical context, and a controller for performing control in such a way that the information of the detected surrounding physical context is displayed through the display unit, and the information of the detected surrounding physical context and the information received through the wireless communication unit are transmitted to adjacent node modules.

In accordance with another aspect of the present invention, a ubiquitous wireless network system is provided. The system comprises an administration server for outputting information inputted by an administrator, a plurality of node modules for displaying corresponding information when arrival destination of the information transmitted from the administration sever is its own node module and for transmitting the corresponding information to adjacent modules when the arrival destination of the information transmitted from the administration sever is not its own node module, and a base module for receiving the information outputted from the administration server and transmitting it to another adjacent node modules.

In accordance with another aspect of the present invention, another ubiquitous wireless network system is provided. The system comprises an administration server for collecting information, a plurality of node modules for displaying detected information and for transmitting the detected information and received information to adjacent modules, and a base module for transmitting the received information from the adjacent node modules of the plurality of node modules to the administration server.

In accordance with another aspect of the present invention, an operation method of a ubiquitous wireless network node module is provided. The method comprises receiving information, determining as to whether arrival destination of the received information is its own node module, displaying corresponding information when the determination is positive, and transmitting the corresponding information to an adjacent node module when the determination is negative.

In accordance with another aspect of the present invention, another operation method of a ubiquitous wireless network node module is provided. The method comprises receiving information, detecting a surrounding physical context, displaying information of the detected surrounding physical context, and transmitting the information of the detected surrounding physical context and the received information to an adjacent node module.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a ubiquitous wireless network system according to a first exemplary embodiment of the present invention;

FIG. 2 is a configuration view illustrating a node module according to the first exemplary embodiment of the present invention, applied to the ubiquitous wireless network system of FIG. 1;

FIG. 3 is a flow chart describing an operation method of the node module of FIG. 2 according to the first exemplary embodiment of the present invention;

FIG. 4 is a schematic view illustrating a ubiquitous wireless network system according to a second embodiment of the present invention;

FIG. 5 is a configuration view illustrating a node module according to the second exemplary embodiment of the present invention, applied to the ubiquitous wireless network system of FIG. 4; and

FIG. 6 is a flow chart describing an operation method of the node module of FIG. 5 according to the second exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of the exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

### Embodiment 1

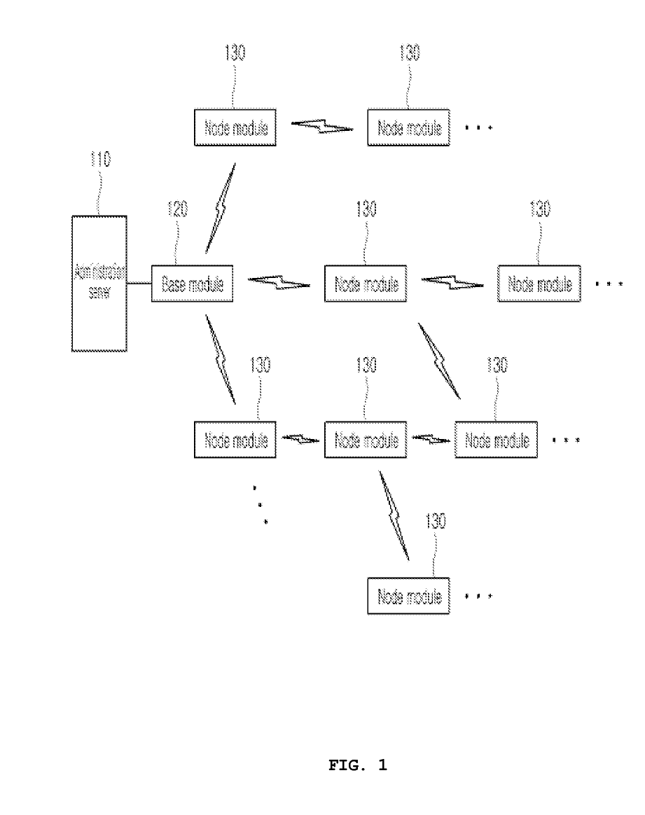

FIG. 1 is a schematic view illustrating a ubiquitous wireless network system according to a first exemplary embodiment of the present invention, which is configured to include an administration server 110, a plurality of node modules 130, and a base module 120.

The administration server 110 serves to output information, inputted by an administrator, to the base module 120. The information includes many pieces of information to be displayed at the respective node modules 130 including the base module. The administration server 110 transmits corresponding information to the respective node module 130 through the base module 120. More specifically, the administration server 110 transmits the corresponding information intended to be sent to the corresponding node module 130 to the base module 120, together with the address information of corresponding node module 130, such as, inherent ID.

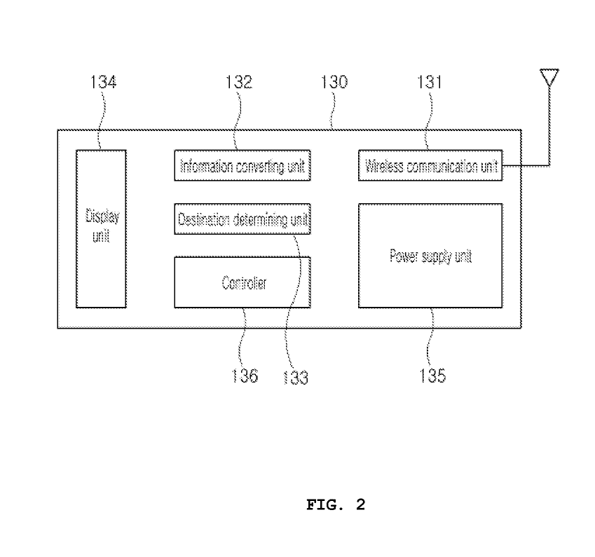

The plurality of node modules 130 performs mutual wireless communication among adjacent node modules 130, including the base module 120. These node modules 130 will be described in detail with reference to FIG. 2.

FIG. 2 is a configuration view illustrating a node module 130 that is configured to include a wireless communication unit 131, information converting unit 132, destination determining unit 133, display unit 134, power supply unit 135, and controller 136.

The wireless communication unit 131 serves to perform wireless communications between adjacent node modules 130 and between the base module 120 and node modules 130 adjacent thereto. Preferably, the wireless communication unit 131 is implemented with an RF transceiver.

The information converting unit 132 serves to convert RF information received by the wireless communication unit 131 to digital information or covert digital information, intended to be transmitted through the wireless communication unit 131, to RF information. The information converting unit 132 is preferably implemented to include an analog-digital (A/D) converter and digital-analog (D/A) converter, which are commonly used.

When the information converting unit 132 converts the information that the wireless communication unit 131 received from the node module 130 to digital information and outputs it to the destination unit 133, the destination determining unit 133 determines as to whether the information arrives at a corresponding destination (i.e., corresponding node module). Here, the destination determining unit 133 determines the arrival destination based on address information transmitted from the administration server 10.

When the destination determining unit 133 determines that the arrival destination of the information corresponds to itself (its own node module), the display unit 134 outputs the corresponding information. The display unit 134 is preferably implemented by a general display device.

The power supply unit 135 serves to supply driving power, and is preferable to be implemented by a battery for installation convenience. As well, the power supply unit 135 may be implemented with an external AC power source.

Based on the determination of the destination determining unit 133 for the arrival destination of the received information, if the arrival destination is itself (its own node module), the controller 136 performs control so that the received information can be outputted through the display unit 134. On the other hand, if the arrival destination of the received information is not itself (not its own node module), the controller 136 performs control so that the received information can be transmitted to another node module 130 adjacent to its own node module through the information converting unit 132 and the wireless communication unit 131.

The base module 120 has the same configuration as each node module 130. As well, the base module 120 can be configured to further include a wired communication unit (not shown) for performing wired communication with the administration server 110.

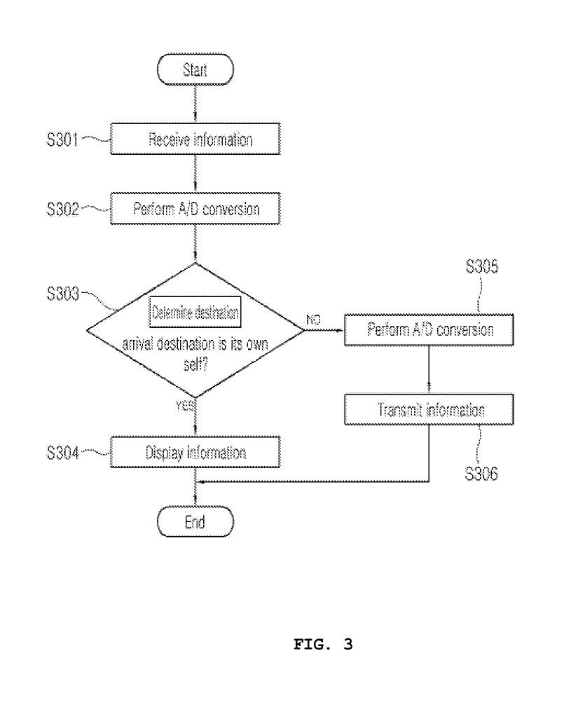

The following is a description of an operation method of a node module 130 according to the first exemplary embodiment of the present invention, referring to the flow chart shown in FIG. 3.

The wireless communication unit 131 receives information from the node module 130 adjacent to its own node module (hereinafter, referred to as an adjacent node module) (S301). Here, the received information of the wireless communication unit 131 includes information, inputted by an administrator through the administration server 110, and address information of a specific node module 120 that intends to display corresponding information.

As well, the information converting unit 132 converts analog information, received through the wireless communication unit 131, to digital information (S302).

The destination determining unit 133 takes the address information from the digital information of the information converting unit 132. After that, the destination determining unit 133 determines where arrival destination of the corresponding information is, that is, whether the arrival destination of the corresponding information is itself (its own node module) or other node modules (S303).

When the destination determining unit 133 determines that the arrival destination is itself (its own node module), the controller 136 performs control in such a way that the display unit 134 displays the information corresponding to itself (its own node module) (S304).

On the other hand, when the destination determining unit 133 determines that the arrival destination is not itself (not its own node module), the controller 136 performs control in such a way that the information converting unit 132 converts the digital information to analog information (S305), and then transmits the analog information to an adjacent node module through the wireless communication unit 131 (S306).

### EXAMPLE OF EMBODIMENT 1

The following is an example where Embodiment 1 of the present invention is used.

A display floor, in a place such as a super-center, compactly displays many products on (the shelving units), and includes labels attached to the shelves above or below where the products are exhibited, describing the products' information, such as, price, origin of the product, and information of trademark change, etc.

Here, the products displayed on the display frames, etc., may be replaced by different kinds of products within the same display as the types of the products are changed. In this case, with a conventional method, labels are manually replaced or relocated and their descriptive information must be manually altered.

However, according to Embodiment 1 of the present invention, the ubiquitous wireless network system is operated in such a way that: the respective node modules 130 are placed at corresponding display frames. When a product displayed on a specific display space is replaced with another product or when a plurality of node modules 130 is placed at new display spaces, an administrator designates a node module 130 (that is, an address allocation) which displays information of the product on the specific display space, through the administration server 110, and then inputs information for the replaced product or new product, displayed at the specific display space, to transmit the information to the corresponding node module 130. The information passes through the base module 120 and the respective node modules 130 and arrives at the corresponding node module 130 of the specific display space displaying the replaced product or new product. The corresponding node module 130 receives the corresponding information and then determines as to whether the arrival destination is itself (its own node module), and when the arrival destination corresponds to itself (i.e., the corresponding node module 130), the corresponding information is displayed on the display unit 134. On the other hand, when the arrival destination does not correspond to itself (i.e., the corresponding node module 130), the corresponding node module 130 transmits the corresponding information to another node module 130 adjacent thereto. Such a procedure is repeated until specific information displayed at a specific node module 130 arrives at the corresponding specific node module 130 to be displayed through the corresponding specific node module 130.

That is, when products are replaced at a plurality of display spaces or new products are displayed thereat, the administrator only inputs and transmits information corresponding to the products through the administration server 110. Then, the information is transferred to the corresponding node modules 130 and displayed correctly thereon. Therefore, consumer reads the information of the corresponding product.

On the other hand, it will be easily appreciated to those skilled in the art that there are many modifications from the embodiment 1.

### Embodiment 2

The following is a description of a second embodiment of the ubiquitous wireless network system according to the present invention, omitting the same that as the first embodiment or briefly describing it.

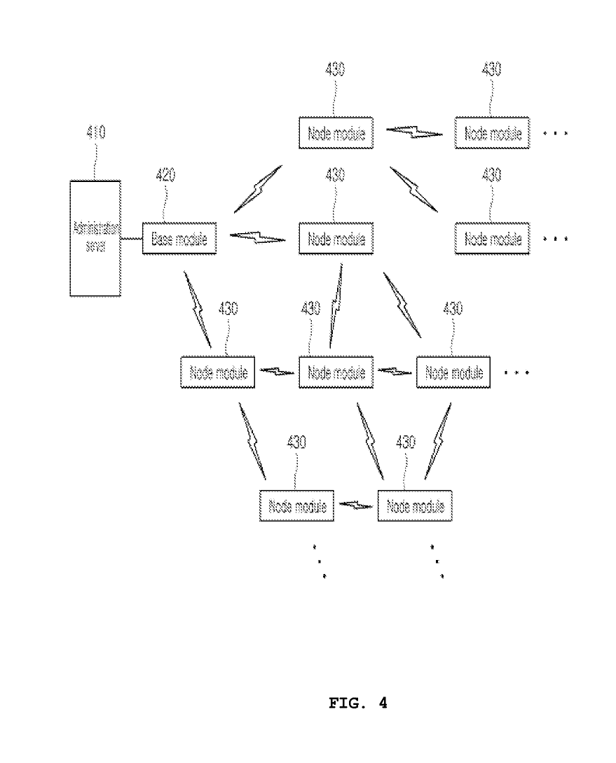

FIG. 4 is a schematic view illustrating a ubiquitous wireless network system according to a second exemplary embodiment of the present invention. Similar to the first exemplary embodiment of FIG. 2, the second exemplary embodiment is configured to include an administration server 410, a plurality of node modules 430, and a base module 420.

The administration server 410 collects information from the respective node modules 430 through the base module 420 and monitors them based on the information.

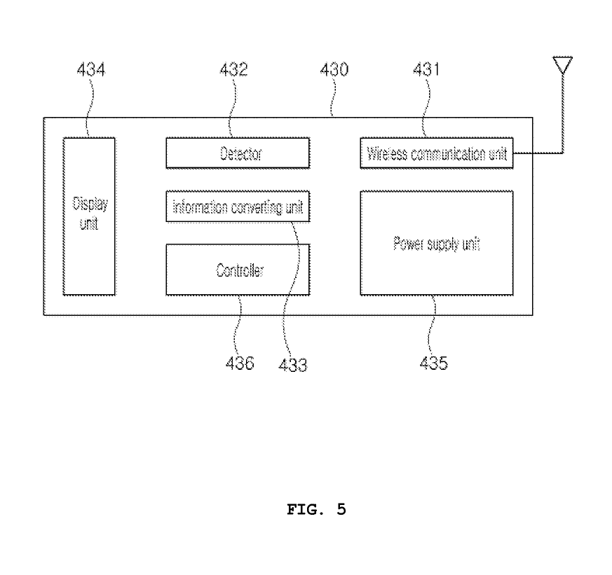

The plurality of node modules 430 performs mutual wireless communication among adjacent node modules 130, including the base module 420. As well, the node modules 430 display the detected information, and transmit the detected information and the received information to adjacent node modules 430. Eventually, the information is transmitted to the administration server 410 through the base module 420. To this end, as shown in FIG. 5, each node module 430 includes a wireless communication unit 431, detector 432, information converting unit 433, display unit 434, power supply unit 435, and controller 436.

The wireless communication unit 431 serves to perform wireless communication between adjacent node modules 430 and between the base module 420 and node module 430 adjacent thereto. Preferably, the wireless communication unit 431 is implemented with an RF transceiver.

The detector 432 serves to detect the physical context, such as, the surrounding temperature, humidity, smoke, gas, etc. The detector 432 can be simply configured to detect only one physical context factor, such as temperature or humidity. Preferably, the detector 432 is configured to include plural sensors to detect plural physical context factors including temperature and humidity.

The information converting unit 433 serves to convert analog information detected by the detector 432 to digital information or digital information to analog (RF) information.

The display unit 434 serves to display the digital information converted by the information converting unit 433.

The power supply unit 435 serves to supply driving power.

The controller 436 performs control in such a way that the digital information, detected by the detector 432 and converted by the information converting unit 433, is outputted through the display unit 434, and the analog information, converted from the digital information by the information converting unit 433, is transmitted to adjacent node modules 430 adjacent through the wireless communication unit 431, thereby transmitting corresponding information to the administration server 410. The information received from the adjacent node module 430 by the wireless communication unit 431 is retransmitted to other adjacent node modules 430.

The base module 420 has the same configuration as each node module 430. As well, the base module 420 can be configured to further include a wired communication unit (not shown) for performing wired communication with the administration server 410.

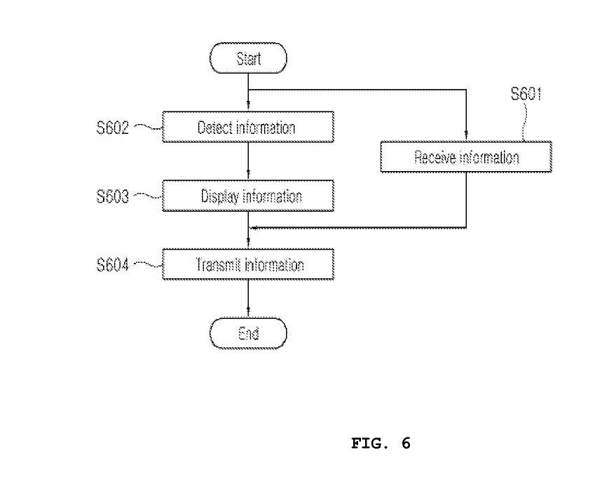

The following is a description of an operation method of a node module 430 according to the second exemplary embodiment of the present invention, referring to the flow chart shown in FIG. 6.

The wireless communication unit 431 receives information from adjacent node modules 430 (S601). Here, the received information includes information of surrounding physical context detected by a node module 430.

The detector 432 detects the surrounding physical context, such as the temperature, humidity, etc. (S602). The information converting unit 433 converts the analog information detected by the detector 432 to digital information.

The controller 436 performs controls in such a way that the digital information of the surrounding physical context is outputted through the display unit 434 (S603), and the digital information is converted to analog information through the information converting unit 433 to transmit the analog information to another node module through the wireless communication unit 431 (S604). The information received by the wireless communication unit 431 is also transmitted to the other adjacent node modules 430.

As described above, although the ubiquitous wireless network system according to certain exemplary embodiment of the present invention is explained based on the respective first and second embodiments, it may be implemented in such a way to combine the first embodiment with the second embodiment.

As apparent from the above description, the ubiquitous wireless network system according to the present invention has the following effects:

Firstly, since the respective node modules include a display unit to display information detected thereby, users can read the information about the physical context, etc., in the spaces at which the respective node modules are placed.

Secondarily, since the respective modules can display information transmitted from the administration server, the ubiquitous wireless network system of the present invention can be used for various and new uses, which is quite different from the conventional ubiquitous wireless network system that just collects information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims and their equivalents.

What is claimed is:

1. A ubiquitous wireless network node module comprising:
a wireless communication unit for transmitting/receiving information between adjacent node modules;
a destination determining unit for determining arrival destination of the information received through the wireless communication unit;
a display unit for displaying the information when the arrival destination is its own node module; and
a controller for performing control in such a way that the information is displayed through the display unit when the arrival destination of the information is its own node module and is transmitted to adjacent node modules through the wireless communication unit when the arrival destination of the information is not its own node module.

2. A ubiquitous wireless network node module comprising:
a wireless communication unit for transmitting/receiving information between adjacent node modules;
a detector for detecting a surrounding physical context;
a display unit for displaying information of the detected surrounding physical context; and
a controller for performing control in such a way that the information of the detected surrounding physical context is displayed through the display unit, and the information of the detected surrounding physical context and the information received through the wireless communication unit are transmitted to adjacent node modules.

3. A ubiquitous wireless network system comprising:
an administration server for outputting information inputted by an administrator;
a plurality of node modules for displaying corresponding information when arrival destination of the information transmitted from the administration sever is its own node module and for transmitting the corresponding information to adjacent modules when the arrival destination of the information transmitted from the administration sever is not its own node module; and
a base module for receiving the information outputted from the administration server and transmitting it to another adjacent node modules.

4. A ubiquitous wireless network system comprising:
an administration server for collecting information;
a plurality of node modules for displaying detected information and for transmitting the detected information and received information to adjacent modules; and
a base module for transmitting the received information from the adjacent node modules of the plurality of node modules to the administration server.

5. An operation method of a ubiquitous wireless network node module comprising the steps of:
receiving information;
determining as to whether arrival destination of the received information is its own node module;
displaying corresponding information when the determination is positive; and
transmitting the corresponding information to an adjacent node module when the determination is negative.

6. An operation method of a ubiquitous wireless network node module comprising the steps of:
receiving information;
detecting a surrounding physical context;
displaying information of the detected surrounding physical context; and
transmitting the information of the detected surrounding physical context and the received information to an adjacent node module.
